(19) United States
(12) Patent Application Publication
(10) Pub. No.: US 2014/0125773 A1
(43) Pub. Date: May 8, 2014

(54) IMAGE PROCESSING METHODS AND APPARATUS

(71) Applicant: KABUSHIKI KAISHA TOSHIBA, Minato-ku (JP)

(72) Inventors: Atsuto MAKI, Cambridge (GB); Riccardo Gherardi, Cambridge (GB); Oliver Woodford, Cambridge (GB); Frank Perbet, Cambridge (GB); Minh-Tri Pham, Cambridge (GB); Bjorn Stenger, Cambridge (GB); Sam Johnson, Cambridge (GB); Roberto Cipolla, Cambridge (GB)

(73) Assignee: KABUSHIKI KAISHA TOSHIBA, Minato-ku (JP)

(21) Appl. No.: 14/072,427

(22) Filed: Nov. 5, 2013

(30) Foreign Application Priority Data
Nov. 5, 2012 (GB) 1219844.6

(51) Int. Cl. G06T 7/40; H04N 13/02; G06T 7/00

(52) U.S. Cl. CPC G06T 7/408; G06T 7/0075; H04N 13/0239
USPC 348/47; 382/162; 382/154

(57) ABSTRACT

A method of calculating a similarity measure between first and second image patches, which include respective first and second intensity values associated with respective elements of the first and second image patches, and which have a corresponding size and shape such that each element of the first image patch corresponds to an element on the second image patch. The method: determines a set of sub-regions on the second image patch corresponding to elements of the first image patch and having first intensity values within a range defined for that sub-region; calculates variance, for each sub-region of the set over all of the elements of that sub-region, of a function of the second intensity value associated with that element and the first intensity value associated with the corresponding element of the first image patch; and calculates similarity measure as the sum over all sub-regions of the calculated variances.

### CROSS-REFERENCE TO RELATED APPLICATIONS

This application is based upon and claims the benefit of priority from United Kingdom Patent Application Number 1219844.6 filed on 5 Nov. 2012; the entire content of which is incorporated herein by reference.

### FIELD

Embodiments described herein relate generally to image processing methods which include the calculation of a similarity measure of two image patches.

### BACKGROUND

The calculation of a similarity measure between regions of different images plays a fundamental role in many image analysis applications. These applications include stereo matching, multimodal image comparison and registration, motion estimation, image registration and tracking.

Matching and registration techniques in general need to be robust to a wide range of transformations that can arise from non-linear illumination changes caused by anisotropic radiance distribution functions, occlusions or different acquisition processes. Examples of different acquisition processes are visible and infrared, and different medical image acquisition techniques such as X-ray, magnetic resonance imaging and ultra sound.

### BRIEF DESCRIPTION OF THE DRAWINGS

In the following, embodiments will be described with reference to the drawings in which:

FIG. 1 shows an image processing system according to an embodiment;

FIG. 2 shows a first image patch and a second image patch;

FIG. 3 shows a method of calculating a similarity measure between two image patches according to an embodiment;

FIG. 4 shows an example of a joint histogram for two image patches;

FIG. 5 shows the effects of quantisation and displacement on a joint histogram;

FIG. 6 shows a comparison of results of the sum of conditional variances method and the sum of conditional variance of differences method;

FIG. 7 shows the results of comparing the performance of different similarity measures on a synthetic registration task using a gradient descent search;

FIG. 8 shows an example of the use of sum of conditional variance of differences method in tracking an object over frames of a video sequence;

FIG. 9 shows a method of calculating a measure of similarity between image patches according to an embodiment;

FIG. 10 shows an image processing apparatus according to an embodiment;

FIG. 11 shows the calculation of depth from disparity or the shift between a left image and a right image of a stereo image pair;

FIG. 12 shows a method of generating a depth image from a stereo image pair according to an embodiment;

FIG. 13 shows two medical image capture devices;

FIG. 14 shows an image processing system according to an embodiment;

FIG. 15 shows a method of registering multimodal images according to an embodiment.

### DETAILED DESCRIPTION

In an embodiment a method of calculating a measure of similarity between a first image patch and a second image patch, the first image patch comprising a plurality of first intensity values each associated with an element of the first image patch, the second image patch comprising a plurality of second intensity values each associated with an element of the second image patch, the first image patch and the second image patch having a corresponding size and shape such that each element of the first image patch corresponds to an element on the second image patch, comprises
determining a set of sub regions on the second image patch, each sub region being determined as the set of elements of the second image patch which correspond to elements of the first image patch having first intensity values within a range of first intensity values defined for that sub region;
for each sub region of the set of sub regions, calculating the variance, over all of the elements of that sub region, of a function of the second intensity value associated with that element and the first intensity value associated with the corresponding element of the first image patch; and
calculating the similarity measure as the sum over all sub regions of the calculated variances.

In an embodiment the function of the second intensity value associated with an element and the first intensity value associated with the corresponding element of the first image patch is the difference between the second intensity value associated with the element and the first intensity value associated with the corresponding element of the first image patch.

In an embodiment the function of the second intensity value associated with an element and the first intensity value associated with the corresponding element of the first image patch is the ratio of the second intensity value associated with the element and the first intensity value associated with the corresponding element of the first image patch.

In an embodiment the first image patch and the second image patch are two dimensional images patches and the elements of the first image patch and the second image patch are pixels.

In an embodiment the first image patch and the second image patch are three dimensional images patches and the elements of the first image patch and the second image patch are voxels.

In an embodiment a method of deriving a depth image from a first image and a second image comprises calculating a plurality of disparities between pixels of the first image and the second image by, for each of a plurality of pixels of the first image, defining a first patch centred on a target pixel of the first image defining a plurality of second image patches centred on pixels of the second image; calculating a measure of similarity between the first image patch and each second image patch of the plurality of second image patches using a method of calculating a measure of similarity between a first image patch and a second image patch according to an embodiment; selecting the second image patch having the best similarity measure as a match for the first image patch centred on the target pixel; and determining the disparity between the target pixel and the pixel of the second image in the centre of the second image patch selected as the match; and calculating a depth image from the plurality of disparities.

In an embodiment the plurality of second image patches are selected as patches centred on pixels on an epipolar line.

In an embodiment an image registration method of determining a transform between a first image and a second image, comprises calculating a measure of similarity between a first image patch of the first image and a second image patch of the second image.

In an embodiment the first image and the second image are obtained from different image capture modalities.

In an embodiment an image processing apparatus comprises a memory configured to store data indicative of a first image patch and a second image patch, the first image patch comprising a plurality of first intensity values each associated with an element of the first image patch, the second image patch comprising a plurality of second intensity values each associated with an element of the second image patch, the first image patch and the second image patch having a corresponding size and shape such that each element of the first image patch corresponds to an element on the second image patch; and a processor configured to determine a set of sub regions on the second image patch, each sub region being determined as the set of elements of the second image patch which correspond to elements of the first image patch having first intensity values within a range of first intensity values defined for that sub region; for each sub region of the set of sub regions, calculate the variance, over all of the elements of that sub region, of a function of the second intensity value associated with that element and the first intensity value associated with the corresponding element of the first image patch; and calculate a similarity measure between the first image patch and the second image patch as the sum over all sub regions of the calculated variances.

In an embodiment the function of the second intensity value associated with an element and the first intensity value associated with the corresponding element of the first image patch is the difference between the second intensity value associated with the element and the first intensity value associated with the corresponding element of the first image patch.

In an embodiment the function of the second intensity value associated with an element and the first intensity value associated with the corresponding element of the first image patch is the ratio of the second intensity value associated with the element and the first intensity value associated with the corresponding element of the first image patch.

In an embodiment the first image patch and the second image patch are two dimensional images patches and the elements of the first image patch and the second image patch are pixels.

In an embodiment the first image patch and the second image patch are three dimensional images patches and the elements of the first image patch and the second image patch are voxels.

In an embodiment an Imaging system comprising: a first camera configured to capture a first image of a scene a second camera configured to capture a second image of the scene; and a processing module configured to calculate a plurality of disparities between pixels of the first image and the second image by, for each of a plurality of pixels of the first image, defining a first patch centred on a target pixel of the first image; defining a plurality of second image patches centred on pixels of the second image; calculating a measure of similarity between the first image patch and each second image patch of the plurality of second image patches; selecting the second image patch having the best similarity measure as a match for the first image patch centred on the target pixel; and determining the disparity between the target pixel and the pixel of the second image in the centre of the second image patch selected as the match; and calculating a depth image of the scene from the plurality of disparities.

In an embodiment the processor is further configured to select the plurality of second image patches as patches centred on pixels on an epipolar line.

In an embodiment the imaging system is an underwater imaging system

In an embodiment the processor is further configured to determine a transform between a first image and a second image, by calculating a measure of similarity between a first image patch of the first image and a second image patch of the second image.

In an embodiment the apparatus further comprises an input module configured to receive the first image and the second image from different image capture modalities.

In an embodiment a computer readable medium carries processor executable instructions which when executed on a processor cause the processor to carry out a method of calculating a measure of similarity between a first image patch and a second image patch.

Embodiments of the present invention can be implemented either in hardware or on software in a general purpose computer. Further embodiments of the present invention can be implemented in a combination of hardware and software. Embodiments of the present invention can also be implemented by a single processing apparatus or a distributed network of processing apparatus.

Since the embodiments of the present invention can be implemented by software, embodiments of the present invention encompass computer code provided to a general purpose computer on any suitable carrier medium. The carrier medium can comprise any storage medium such as a floppy disk, a CD ROM, a magnetic device or a programmable memory device, or any transient medium such as any signal e.g. an electrical, optical or microwave signal.

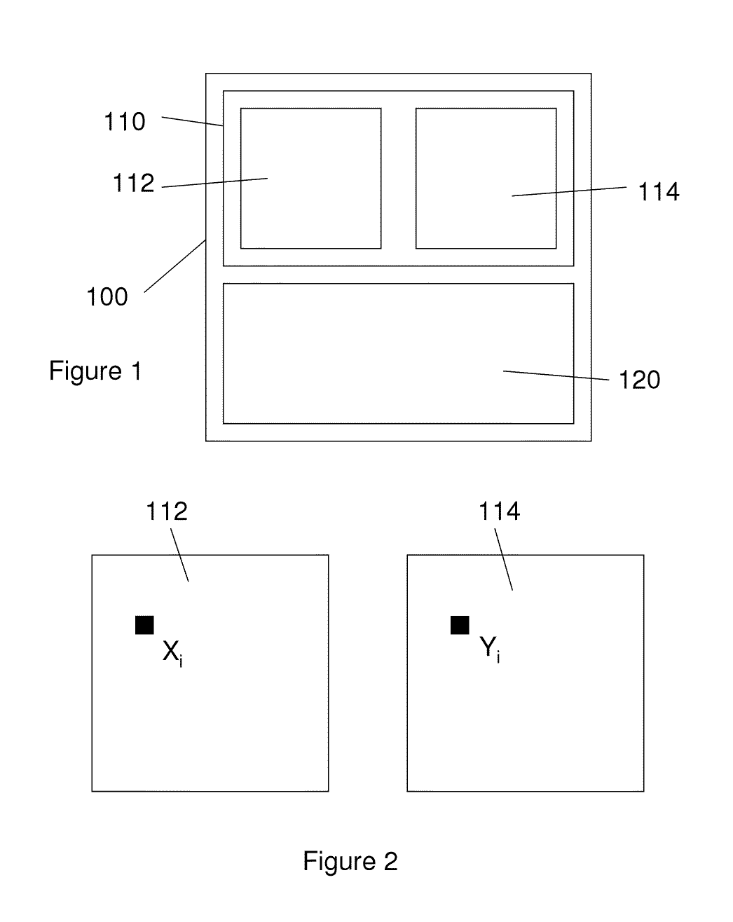

FIG. 1 shows an image processing system according to an embodiment. The image processing system 100 comprises a memory 110 and a processor 120. The memory 110 stores a first image patch 112 and a second image patch 114. The processor 120 is programmed to carry out an image processing method to generate a measure of similarity between the first image patch 112 and the second image patch 114.

The image processing system 100 has an input for receiving image signals. The image signals comprise image data. The input may receive data from an image capture device. In an embodiment, the input may receive data from a network connection. In an embodiment, the data may comprise images from different image capture modalities.

FIG. 2 shows the first image patch 112 and the second image patch 114. The first image patch has a plurality of pixels. In FIG. 2, the ith pixel of the first image patch is labelled as Xi. The second image patch 114 also has a plurality of pixels. The first image patch 112 and the second image patch 114 both have the same number of pixels. Each pixel in the first image patch 112 corresponds to a pixel of the second image patch 114. FIG. 2 shows the ith pixel of the second image patch 114 as Yi. The pixel Xi of the first image patch corresponds to the pixel Yi of the second image patch. An intensity value is associated with each pixel.

While the image patches described above have the same shape and size, they may have been transformed or rectified from images of different sizes or shapes.

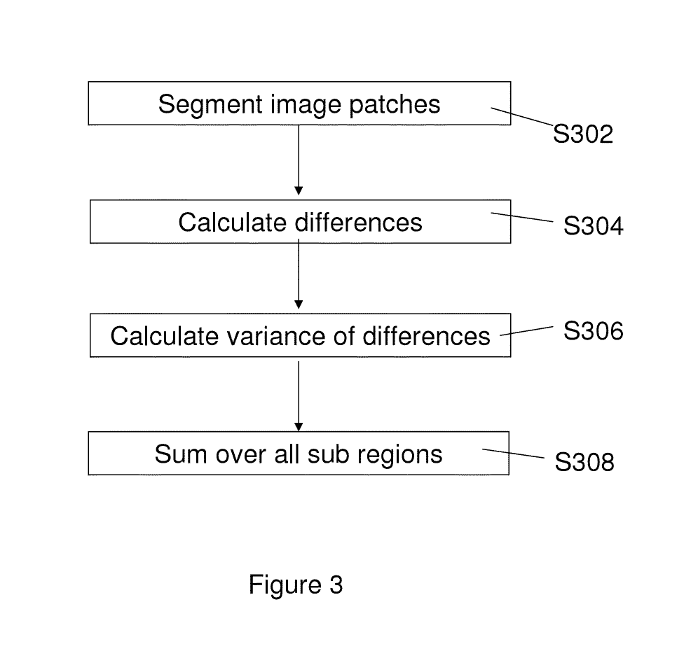

FIG. 3 is a flowchart showing a method of calculating a similarity measure between a first image patch and a second image patch according to an embodiment. The method shown in FIG. 3 may be implemented by the processor 120 shown in FIG. 1 to calculate a measure of similarity between the first image patch 112 and the second image patch 114 shown in FIG. 2.

In step S302, the second image patch is segmented into a plurality of subregions. The second image patch is segmented by defining regions according to the intensity of the where Xᵢ and Yᵢ with i=1, . . . , Nₚ indicate the pixel intensities of X and Y respectively, Np being the total number of pixels. The conditions that appear in the sum are obtained uniformly partitioning the intensity range of X.

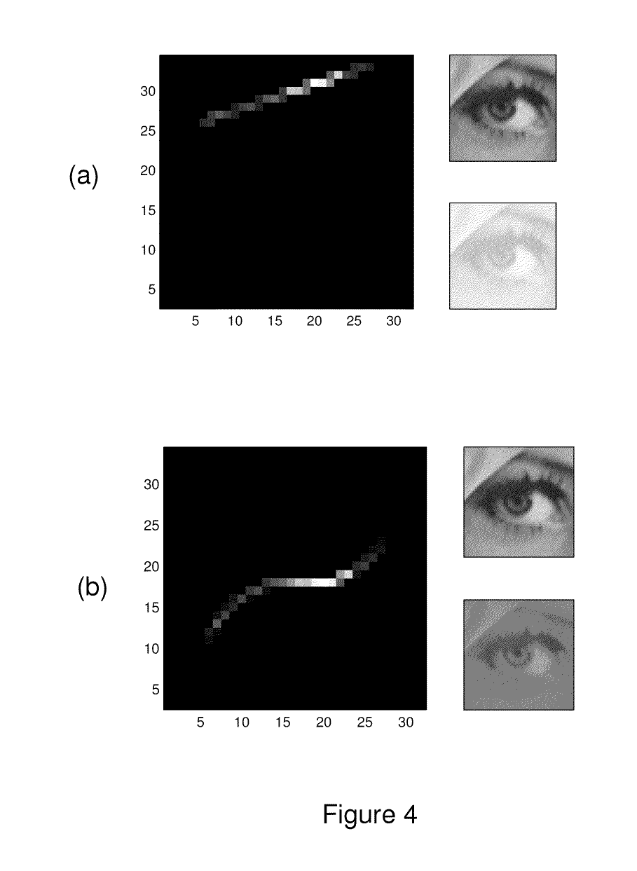

FIG. 4 shows an example of a joint histogram for images X and Y. The behaviour of SCV can be characterised by the joint histogram. As shown in FIG. 4, the joint histogram can be interpreted as non-injective relation that maps the range of the first image to the second one.

A joint histogram H_{XY} can be interpreted as non-injective relation that maps the ranges of two images. FIG. 4a shows the resulting joint histogram after linearly reducing the contrast of the reference image. FIG. 4b shows the joint histogram for a non-linear intensity map. Hotter (brighter) colours correspond to more frequently occurring values.

The set of pixels that contributed to the non zero entry of each column (row) corresponds to one of the regions selected by the j-th condition. The number of discretisation levels nb is problem specific; for images quantised at byte precision, a typical choice is usually n_{b}=32 or 64. Larger intervals can help in achieving a wider convergence radius and offer more resilience to noise. The matching measure will not change as long as the pixels do not cross the current bin boundaries. On the other hand, narrow ranges will boost the matching accuracy and reduce the information that is lost during the quantisation step.

According to the SCV algorithm, the reference image is used solely to determine the subregions in which the variances of the equation above for S_{SCV}(X,Y) should be computed.

In embodiments described herein a similarity measure based on the conditional variance of differences is used. Thus all the information present in both images is used leading to a more discriminative matching measure.

First, the variance of differences (VD) is defined as the second moment of the intensity differences between two templates:

pixels of the first image patch. On the first image patch each subregion is defined as the set of pixels having intensities within a range of values. The subregions on the second image patch are defined as the sets of pixels of the second image patch which have locations corresponding to pixels within a given subregion on the first image patch.

In step S304 for each region on the second image patch the difference in intensity between the pixels of the second image patch and the corresponding pixels of the first image patch is calculated.

In step S306, the variance of the difference in intensity over each subregion is calculated.

In step S308, the sum of the variances over all subregions is calculated and taken as a measure of similarity between the first image patch and the second image patch.

The method described above in relation to FIG. 3 may be considered be the calculation of Sum of Conditional Variance of Differences (SCVD). The SCVD method is a variant of the Sum of Conditional Variances method (SCV).

The SCV method and the SCVD methods will now be described in more detail. Given a pair of images X and Y, the sum of conditional variances (SCV) matching measure prescribes to partition the pixels of Y into n_{b} disjoint bins Y (j) with j=1, . . . , nb, corresponding to bracketed intensity regions X(j) of X (called the reference image which is analogous to the first image described above).

The value of the matching measure is then obtained summing the variances of the intensities within each bin Y (j).

$${S}_{SCV} ( X , Y ) = {\sum }_{j = 1}^{{n}_{b}} E [ {( {Y}_{i} - E ( {Y}_{i} ) )}^{2} \vert {X}_{i} ∈ X ( j ) ]$$

$$VD ( X , Y ) = Var [ {\{ {Y}_{i} - {X}_{i} \}}_{i = 1 … {N}_{p}} ]$$

The variance of differences is minimal when the distribution of differences is uniform. It is bias invariant, scale sensitive and proportional to the zero-mean sum of squared differences.

The fact that it is proportional to the zero-mean sum of squared differences can be verified by the following:

$$VD ( X , Y ) = E [ {( Y - X - E ( Y - X ) )}^{2} ] ∝ {\sum }_{i} {[ ( {Y}_{i} - E ( {Y}_{i} ) ) - ( {X}_{i} - E ( {X}_{i} ) ) ]}^{2}$$

where the mean of an image is understood to indicate its element-wise mean.

Given two images X and Y, we define the sum of the conditional variance of differences (SCVD) as the sum of the variances over a partition of their difference. As before, the subsets are selected bracketing the range of the reference image to produce a set of bins X(j). In symbols:

$${S}_{SCVD} ( X , Y ) = {\sum }_{j = 1}^{{n}_{b}} VD ( {X}_{i} , Φ {Y}_{i} \vert {X}_{i} ∈ X ( j ) )$$

In order for the difference to be meaningful, the two signals should be in direct relation; since the matching measure need be insensitive to changes in scale and bias, we maximise direct relation by adjusting the sign of one of them in accordance with the equation below:

$$Φ = Γ ( {\sum }_{j = 2}^{{n}_{b}} Γ ( E ( {Y}_{i} \vert {X}_{i} ∈ X ( j ) ) - E ( {Y}_{i} \vert {X}_{i} ∈ X ( j - 1 ) ) ) )$$

where Γ indicates the step function mapping R to {−1, 1}. φ encodes a cumulative result of comparisons between a pair of E(Yᵢ) in the adjacent histogram bins, so that the sign is properly adjusted. Hence, the requirement for the mapping from X and Y is to be weakly order preserving. That is, the function should be monotonic but is not required to be injective. This restriction, not present in the original SCV formulation, makes it possible to make better use of the available information and largely valid, e.g. between signals captured for the same target with different modes.

Uniformly partitioning the intensity range of X into equally sized bins X(j) can lead subpar performances when the intensity distribution is uneven: poorly sampled intensity ranges are noisy and their variance unreliable. Overly sampled regions of the spectrum conversely lead to compressing many pixels into a single bin, discarding a large amount of useful information in the process. The procedure is also inherently asymmetric, producing in general different results when swapping the images involved.

In embodiments the method can be modified in two non-mutually exclusive ways to address the issues discussed above. Each one of the modifications provides an independent performance boost to the baseline approach described.

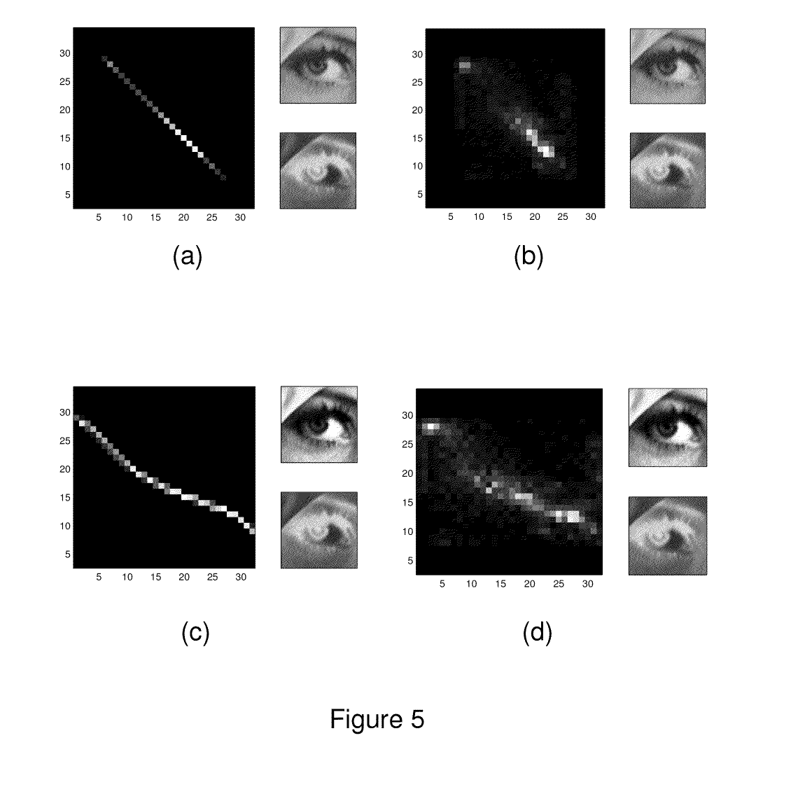

FIG. 5 shows the effects of quantisation and displacement. FIG. 5a shows the histogram H_{XY} for a pair of aligned images in this case, the joint histogram between an image and its gray scale inverse is shown.

FIG. 5b shows the histogram H_{XY} for the same pair of images with a 5 pixel displacement to one of the images.

FIG. 5c shows a histogram H_{XY} for the aligned images, where the intensity range of the image has been equalised.

FIG. 5d shows a histogram H_{XY} for the displaced images, where the intensity range of the image has been equalised.

As it can be seen, in FIGS. 5a and 5b the bins corresponding to the low and high end of the intensity spectrum are not receiving any vote, thus compressing the image information into a smaller number of regions.

To achieve a uniform bin utilisation, a histogram equalisation is performed on the reference image X. FIG. 5c shows an H_{XY} generated by replacing the input reference image X with its histogram equalized version, achieving full utilisation of the entire dynamic range.

As can be seen from FIG. 5, equalising the reference image results in spreading the vote over a larger area, affecting the variance computation and resulting in a more discriminative measure.

Both SCV and SCVD are structurally asymmetrical since only one of the images is used to define the partitions in which to compute the variance.

Generally,

S_{{SCV,SCVD}}(X,Y)≠S_{{SCV,SCVD}}(Y,X)

because the two quantities are computed over different subregions which depends on the reference image. As far as the task of image matching is concerned, no particular reason exists in choosing one image over the other as the reference; the process of quantization can thus be symmetrised computing S_{{SCV,SCVD}} bi-directionally:

S_{{SCV,SCVD}}^{B}=(S_{{SCV,SCVD}}(X,Y)+S_{{SCV,SCVD}}(Y,X))/2

Given the characteristics of SCVD (SCV), in presence of uneven quantizations one direction is usually much more discriminative than the other. The above formula is capable of successfully disambiguating such situations.

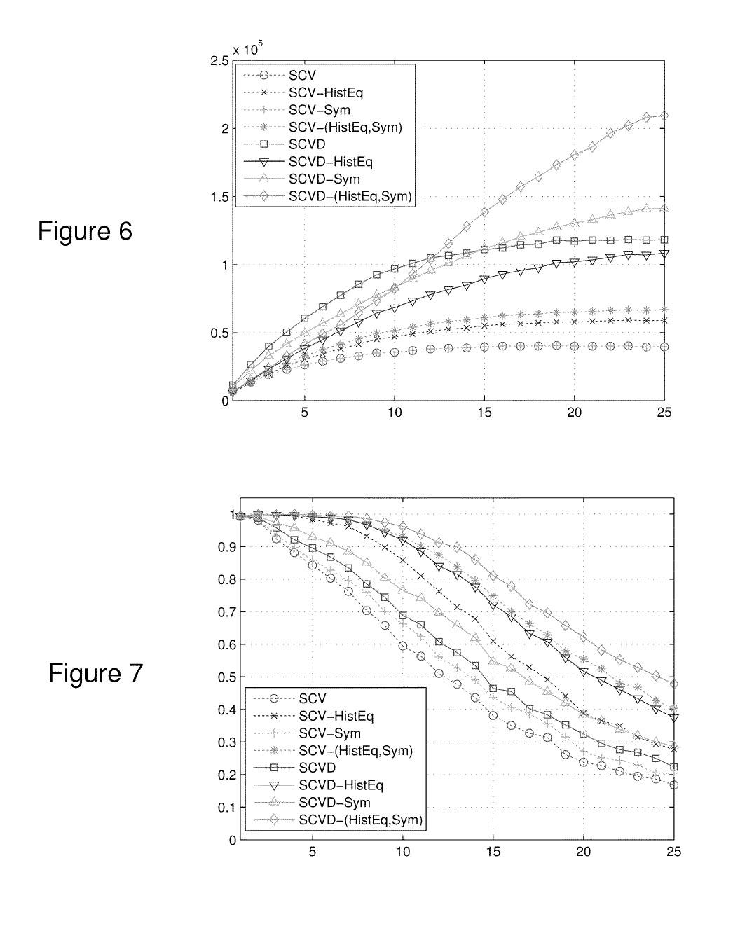

FIG. 6 shows a comparison of the SCV approach, the SCVD approach and the modifications discussed above.

An image location, a direction and a displacement were selected all at random, and the measure between the selected reference window and the template was computed after applying the translation.

Notice that the template is negated in order to simulate multi-modal inputs. The size of the region was fixed to 50×50 pixels while the maximum distance was set to be half of its edge length, i.e. 25 pixels.

FIG. 6 was produced averaging 20,000 iterations of this procedure, to remove the effects of noise (each single trial is roughly monotonic). As it can be seen, all SCVD versions are better at discriminating the minimum. Histogram equalized and symmetric variants obtain steeper gradients for both SCV and SCVD. When utilising both improvements, SCVD shows a nearly constant slope, a crucial property in order to use optimization algorithms based on implicit derivatives.

FIG. 7 shows the results of comparing the performance of different similarity measures on a synthetic registration task using a gradient descent search; given a random location and displacement as before, a cost function following the direction of the steepest gradient was optimised. The procedure terminates when reaching a local minima or the maximum number of allowed iterations. The maximum number of iterations was set to 50 in this case. FIG. 7 was obtained averaging 4000 different trials; as it can be seen, each SCVD version beats the equivalent SCV measure using the same set of variants, which provide a non negligible performance boost.

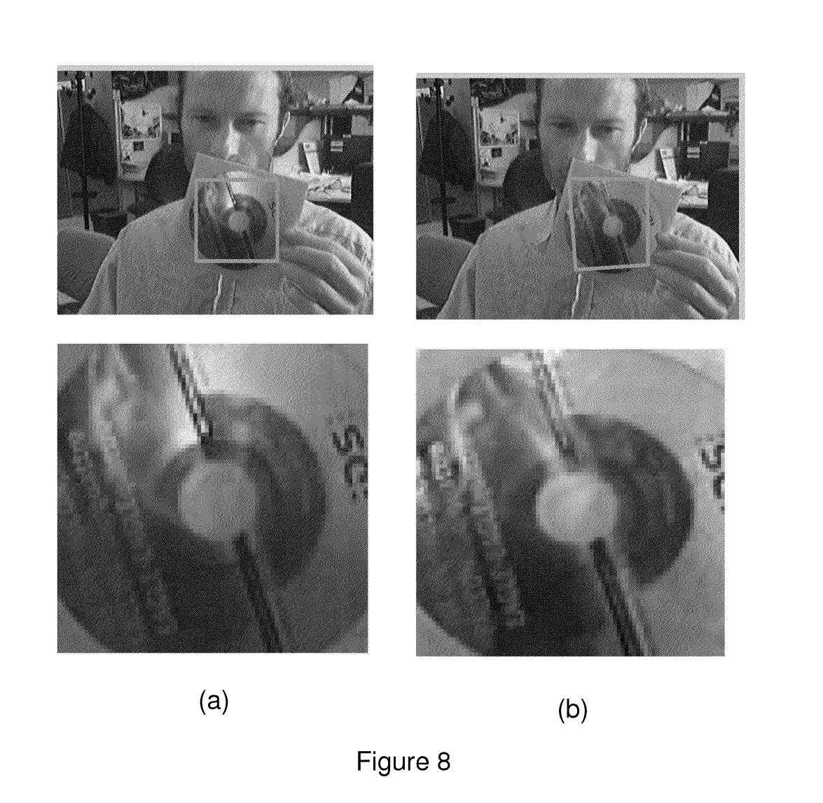

FIG. 8 shows an example of the use of SCVD in tracking an object over frames of a video sequence. FIG. 8a shows one frame of a video sequence and its reference template. The subsequent frame has both photometric and geometric deformations. FIG. 8b shows the registration results for the SCVD method showing both the best matching quadrilateral on the frame and the regions back warped to the reference.

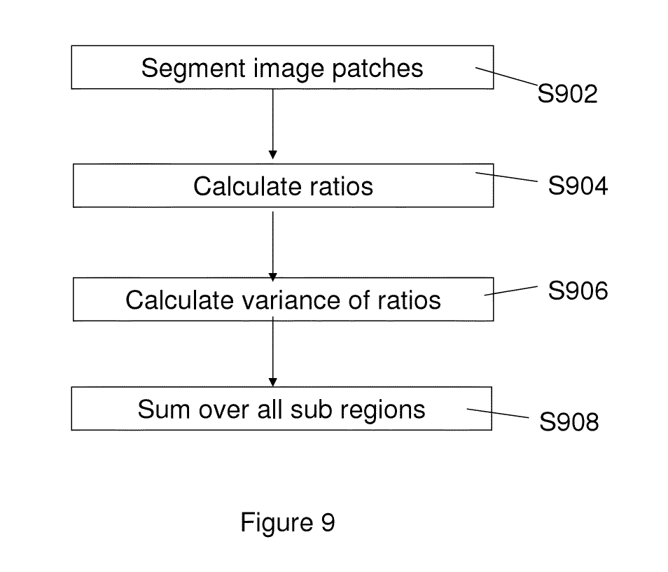

FIG. 9 shows a method of calculating a measure of similarity between image patches according to an embodiment. In the methods discussed above, the conditional variance of differences is calculated. In the method shown in FIG. 9, the conditional variance of ratios of intensity are calculated.

The method shown in FIG. 9 may be implemented by the processor 120 shown in FIG. 1 to calculate a measure of similarity between the first image patch 112 and the second image patch 114 shown in FIG. 2.

In step S902, the second image patch is segmented into a plurality of subregions. The second image patch is segmented using by defining regions according to the intensity of the pixels of the first image patch. On the first image patch each subregion is defined as the set of pixels having intensities within a range of values. The subregions on the second image patch are defined as the sets of pixels of the second image patch which have locations corresponding to pixels within a given subregion on the first image patch.

In step S904 for each region on the second image patch the ratio of the intensity of the pixels of the second image patch and the intensity of corresponding pixels of the first image patch is calculated.

In step S906, the variance of the ratio of the intensity over each subregion is calculated.

In step S908, the sum of the variances over all subregions is calculated and taken as a measure of similarity between the first image patch and the second image patch.

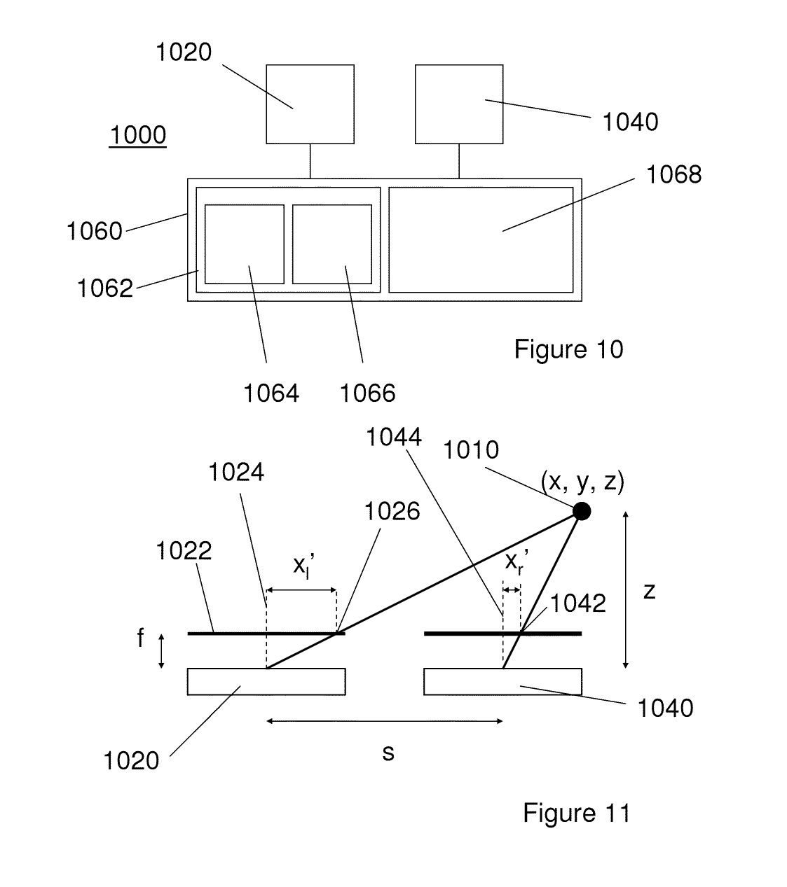

FIG. 10 shows an image processing apparatus according to an embodiment. The apparatus 1000 uses the methods described above to determine a depth image from two images. The apparatus 1000 comprises a left camera 1020 and a right camera 1040. The left camera 1020 and the right camera 1040 are arranged to capture images of approximately the same scene from different locations.

The image processing apparatus 1000 comprises an image processing system 1060 the image processing system 1060 has a memory 1062 and a processor 1068. The memory stores a left image 1064 and a right image 1066. The processor carries out a method to determine a depth image from the left image 1064 and the right image 1066.

FIG. 11 shows how the depth z can be calculated from disparity, or the shift between the left image 1064 and the right image 1066.

The left camera 1020 has an image plane 1022 and a central axis 1024. The right camera has an image plane 1042 and a central axis 1044. The central axis 1024 of the left camera is separated from the central axis 1044 of the right camera by a distance s. The left camera 1020 and the right camera 1040 each have a focal length of f. The cameras may comprise a charge coupled device or other device for detecting photons and converting the photons into electrical signals.

A point 1010 with coordinates (x, y, z) will be projected onto the image place 1022 of the left camera at a point 1026 which is separated from the central axis 1024 of the left camera by a distance xₗ′. The point will be projected onto the image place 1022 of the right camera at a point 1046 which is separated from the central axis 1044 of the right camera by a distance xᵣ′.

The depth z can be calculated as follows:

$$\frac{x}{z} = \frac{{x}_{l}^{′}}{f}$$

The above equation comes from comparing the similar triangles formed by the line running from the left hand camera to the point at co-ordinates (x, y, z).

Similarly considering the line running from the right camera to the point at co-ordinates (x, y, z) the following equation can be derived:

$$\frac{x - s}{z} = \frac{{x}_{r}^{′}}{f}$$

Combining the two equations gives:

$$z = \frac{sf}{{x}_{l}^{′} - {x}_{r}^{′}}$$

Thus, the depth can be obtained from the disparity, x′ₗ−x′ᵣ.

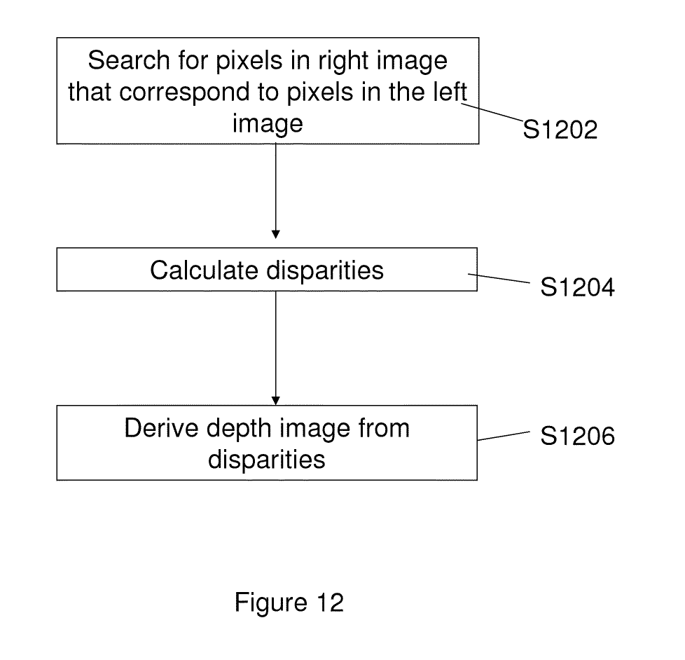

FIG. 12 shows a method of generating a depth image from a stereo image pair according to an embodiment.

In step S1202, a search for pixels in the right hand image that correspond to pixels in the left hand image is carried out. For a plurality of pixels in the left hand image a search is carried out for a corresponding pixel in the right hand image. This search is carried out by forming a first image patch centred on a pixel in the left hand image. Then, a search is carried out over the second image for a second image patch having the highest similarity measure. The similarity measure is calculated as described above. Once the image patch having the highest similarity measure is found, the pixel in the centre of that image patch is taken as the projection of the point onto the right hand image.

In step S1204, the disparity between the two pixels is calculated as the distance between them.

Once disparities have been calculated for a plurality of pixels in the left hand image, a depth image is derived from the disparities in step S1206.

The search carried out in step S1202 may be limited to pixels in the right hand image that are in the plane as the pixel in the left hand image. If the two cameras are aligned this may involve only searching for pixels with the same y coordinate. The plane passing through the camera centres and a given feature point is called the epipolar plane. The intersection of the epipolar plane with the image plane defines the epipolar line. If the epipolar lines of the two cameras are aligned, then every feature in one image will lie on the same row in the second image.

If the two cameras are not aligned the search may be carried out along an oblique epipolar line. The position of the oblique epipolar line may be determined using information on the relative positioning of the cameras. This information may be determined using a calibration board and determining the extent to which the images from one camera are rotated with respect to the other.

Alternatively, if the two cameras are not aligned, the image from one of the cameras may be transformed using the calibration information described above.

Because the methods of calculating similarity measures between image patches of embodiments have a high tolerance to noise in images it is anticipated that the depth calculation described above would be particularly suitable for noisy environments such as underwater environments.

Underwater imaging environments present a number of challenges. While travelling through water, light rays are absorbed and scattered when photons encounter particles in the water or water molecules. This effect depends on the wavelength and therefore has an impact on the colours finally measured by the image sensors and can lead to reduced contrast. Further, refraction when the light enters a camera housing from water into glass and then into air leads to distortion of images.

Because of the effects discussed above, in order to perform stereo image matching and generate a depth image, a similarity measure with a high robustness to noise is required such as that provided by embodiments described herein.

In an embodiment, the size of the image patches may be varied depending on local variations in intensity and the disparity. The image patch size may be varied for each pixel and the image patch size that minimises the uncertainty in the disparity may be selected.

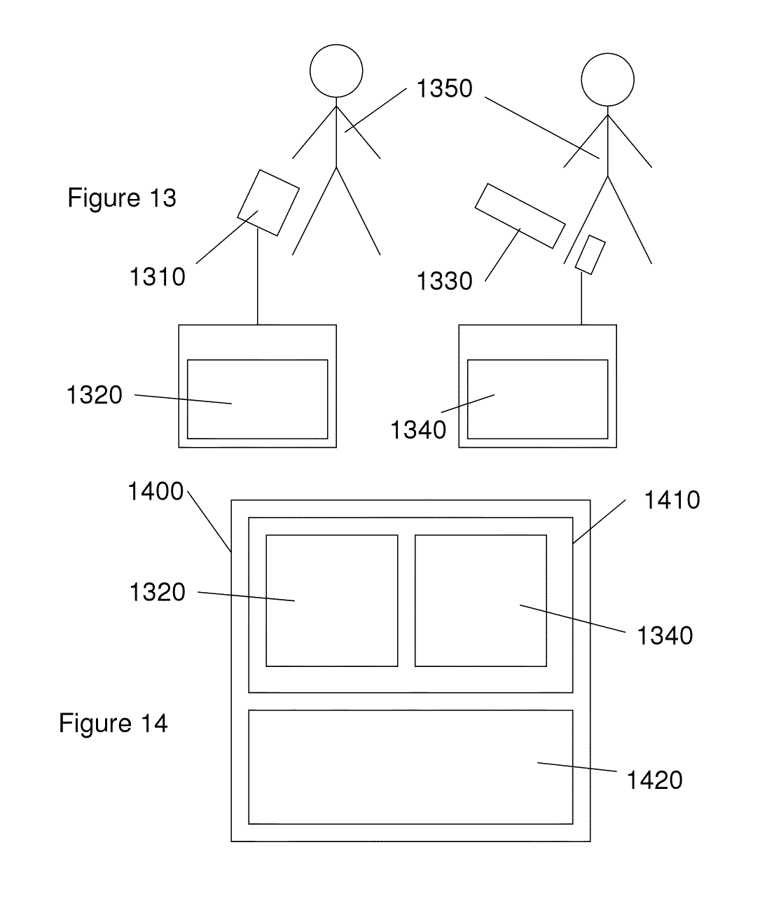

FIG. 13 shows two medical image capture devices. A first image capture device 1310 is configured to capture a first image 1320 of a patient 1350 using a first image capture modality. A second image capture device 1330 is configured to capture a second image 1340 of a patient using a second image capture modality.

For example, the first image capture modality may be x-ray and the second image capture modality may be magnetic resonance imaging.

FIG. 14 shows an image processing system according to an embodiment. The image processing system 1400 is configured to register images obtained with different sensor modalities. For example as shown in FIG. 13 both the first and the second image capture devices capture images of the patient's leg.

The image processing system 1400 has a memory 1410 which stores a first image 1320 and a second image 1340. The image processing apparatus 1400 has a processor 1420 which carries out a method of registering the first image with the second image.

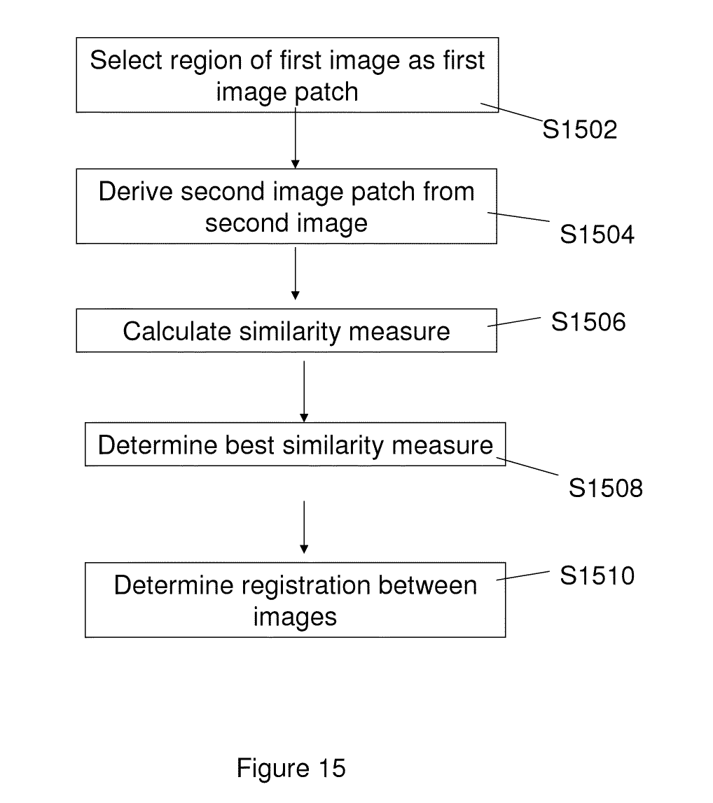

FIG. 15 shows a method which is executed by the system 1400 to register the multimodal images.

In step S1502, a region of the first image is selected as a first image patch. In step S1504, a second image patch is derived from the second image. The second image patch may be derived by transforming or warping parts of the second image. In step S1506 a similarity measure between the first image patch and the second image patch is calculated using one of the methods described above. Steps S1504 and S1506 are repeated until in step S1508 a second image patch having a best similarity measure is determined.

In step S1510 a registration between the images is determined.

The registration between the images may be determined as a transform matrix. The registration between the images may be stored as metadata according to a standard such as the Digital Imaging and Communications in Medicine (DICOM) standard.

While the example described above relates to registration of images from multimodal sensors, the method may also be adapted to the following applications. Atlas mapping: an image of a patient may be mapped to a stored medical atlas, for example a set of anatomical features of the brain. Images of a patient obtained over a period of time may be mapped to one-another. Multiple images of a patient may be stitched together.

While the description above relates to two dimensional images, those of skill in the art will appreciate that the methods and systems described could also be applied to three dimensional images in which patches comprising a number of voxels would be compared to determine a similarity measure.

While certain embodiments have been described, these embodiments have been presented by way of example only, and are not intended to limit the scope of the inventions. Indeed the novel methods and systems described herein may be embodied in a variety of other forms; furthermore, various omissions, substitutions and changes in the form of methods and systems described herein may be made without departing from the spirit of the inventions. The accompanying claims and their equivalents are intended to cover such forms of modifications as would fall within the scope and spirit of the inventions.

1. A method of calculating a measure of similarity between a first image patch and a second image patch,
the first image patch comprising a plurality of first intensity values each associated with an element of the first image patch, the second image patch comprising a plurality of second intensity values each associated with an element of the second image patch,
the first image patch and the second image patch having a corresponding size and shape such that each element of the first image patch corresponds to an element on the second image patch,
the method comprising
determining a set of sub regions on the second image patch, each sub region being determined as the set of elements of the second image patch which correspond to elements of the first image patch having first intensity values within a range of first intensity values defined for that sub region;
for each sub region of the set of sub regions, calculating the variance, over all of the elements of that sub region, of a function of the second intensity value associated with that element and the first intensity value associated with the corresponding element of the first image patch; and
calculating the similarity measure as the sum over all sub regions of the calculated variances.

2. The method of claim 1 wherein the function of the second intensity value associated with an element and the first intensity value associated with the corresponding element of the first image patch is the difference between the second intensity value associated with the element and the first intensity value associated with the corresponding element of the first image patch.

3. The method of claim 1 wherein the function of the second intensity value associated with an element and the first intensity value associated with the corresponding element of the first image patch is the ratio of the second intensity value associated with the element and the first intensity value associated with the corresponding element of the first image patch.

4. The method of claim 1 wherein the first image patch and the second image patch are two dimensional images patches and the elements of the first image patch and the second image patch are pixels.

5. The method of claim 1 wherein the first image patch and the second image patch are three dimensional images patches and the elements of the first image patch and the second image patch are voxels.

6. A method of deriving a depth image from a first image and a second image, the method comprising
calculating a plurality of disparities between pixels of the first image and the second image by,
for each of a plurality of pixels of the first image,
defining a first patch centred on a target pixel of the first image
defining a plurality of second image patches centred on pixels of the second image;
calculating a measure of similarity between the first image patch and each second image patch of the plurality of second image patches using the method of claim 1;
selecting the second image patch having the best similarity measure as a match for the first image patch centred on the target pixel; and
determining the disparity between the target pixel and the pixel of the second image in the centre of the second image patch selected as the match; and
calculating a depth image from the plurality of disparities.

7. The method of claim 6 wherein the plurality of second image patches are selected as patches centred on pixels on an epipolar line.

8. An image registration method of determining a transform between a first image and a second image, comprising calculating a measure of similarity between a first image patch of the first image and a second image patch of the second image according to the method of claim 1.

9. An image registration method according to claim 8 wherein the first image and the second image are obtained from different image capture modalities.

10. An image processing apparatus comprising
a memory configured to store data indicative of a first image patch and a second image patch, the first image patch comprising a plurality of first intensity values each associated with an element of the first image patch, the second image patch comprising a plurality of second intensity values each associated with an element of the second image patch, the first image patch and the second image patch having a corresponding size and shape such that each element of the first image patch corresponds to an element on the second image patch; and
a processor configured to
determine a set of sub regions on the second image patch, each sub region being determined as the set of elements of the second image patch which correspond to elements of the first image patch having first intensity values within a range of first intensity values defined for that sub region;
for each sub region of the set of sub regions, calculate the variance, over all of the elements of that sub region, of a function of the second intensity value associated with that element and the first intensity value associated with the corresponding element of the first image patch; and
calculate a similarity measure between the first image patch and the second image patch as the sum over all sub regions of the calculated variances.

11. The apparatus of claim 10 wherein the function of the second intensity value associated with an element and the first intensity value associated with the corresponding element of the first image patch is the difference between the second intensity value associated with the element and the first intensity value associated with the corresponding element of the first image patch.

12. The apparatus of claim 10 wherein the function of the second intensity value associated with an element and the first intensity value associated with the corresponding element of the first image patch is the ratio of the second intensity value associated with the element and the first intensity value associated with the corresponding element of the first image patch.

13. The apparatus of claim 10 wherein the first image patch and the second image patch are two dimensional images patches and the elements of the first image patch and the second image patch are pixels.

14. The apparatus of claim 10 wherein the first image patch and the second image patch are three dimensional images patches and the elements of the first image patch and the second image patch are voxels.

15. An Imaging system comprising:
a first camera configured to capture a first image of a scene
a second camera configured to capture a second image of the scene; and a processing module configured to calculate a plurality of disparities between pixels of the first image and the second image by,
for each of a plurality of pixels of the first image,
defining a first patch centred on a target pixel of the first image
defining a plurality of second image patches centred on pixels of the second image;
calculating a measure of similarity between the first image patch and each second image patch of the plurality of second image patches using the method of claim 1;
selecting the second image patch having the best similarity measure as a match for the first image patch centred on the target pixel; and
determining the disparity between the target pixel and the pixel of the second image in the centre of the second image patch selected as the match; and
calculating a depth image of the scene from the plurality of disparities.

16. An imaging system according to claim 15 wherein the processor is further configured to select the plurality of second image patches as patches centred on pixels on an epipolar line.

17. An underwater imaging system comprising the imaging system of claim 15.

18. The apparatus of claim 10, wherein the processor is further configured to determine a transform between a first image and a second image, by calculating a measure of similarity between a first image patch of the first image and a second image patch of the second image.

19. The apparatus of claim 18 further comprising an input module configured to receive the first image and the second image from different image capture modalities.

20. A computer readable medium carrying processor executable instructions which when execute on a processor cause the processor to carry out a method according to claim 1.
